(19) United States
(12) Patent Application Publication
(10) Pub. No.: US 2014/0255122 A1
(43) Pub. Date: Sep. 11, 2014

(54) PNEUMATIC SYSTEM

(71) Applicant: Techmaster, Inc., Menomonee Falls, WI (US)

(72) Inventor: Michael J. Radosevic, Wauwatosa, WI (US)

(73) Assignee: Techmaster, Inc., Menomonee Falls, WI (US)

(21) Appl. No.: 14/280,434

(22) Filed: May 16, 2014

Related U.S. Application Data
(63) Continuation-in-part of application No. 14/224,587, filed on Mar. 25, 2014.
Application No. 14/224,587 is a continuation of application No. 12/795,390, filed on Jun. 7, 2010, now Pat. No. 8,701,697.

(51) Int. Cl. B60P 7/06

(52) U.S. Cl. CPC B60P 7/065
USPC 410/119; 137/225

(57) ABSTRACT

A pneumatic cargo stabilization system includes a first line configured to be coupled to a dunnage bag and configured to selectively convey a flow of a gas from a source to the dunnage bag, a second line in fluid communication with the gas in the dunnage bag, and a valve coupled in series with the first line, between the source and the dunnage bag. The valve includes a body that defines pressure supply port, a container port, and an exhaust port, a diaphragm assembly, and a spring member positioned to apply a biasing force to a first side of the diaphragm assembly, the second line conveying a feedback to a second side of the diaphragm assembly that opposes the biasing force.

### CROSS-REFERENCE TO RELATED APPLICATIONS

This application is a continuation-in-part of U.S. application Ser. No. 14/224,587, filed Mar. 25, 2014, which is a continuation of U.S. application Ser. No. 12/795,390, filed Jun. 7, 2010, now U.S. Pat. No. 8,701,697, both of which are hereby incorporated by reference in their entireties.

### BACKGROUND

The present disclosure relates generally to a pneumatic system and associated valves used to control a flow of gas from a higher-pressure source supplied to a lower-pressure container.

One type of lower-pressure container of gas is a dunnage bag. Dunnage bags are used to secure cargo of tractor trailers, railroad cars, and other vehicles. The dunnage bags are inflated on the sides of the cargo, such as between the cargo and walls of the respective vehicle. Once inflated, the dunnage bags provide a secure fit for the cargo in the vehicle, preventing unintended and undesired movement of the cargo during transportation thereof

Typically, the dunnage bags are formed from paper and have an interior that is lined with plastic. Other dunnage bags may be formed entirely from plastic. Paper and plastic materials allow for inexpensive manufacturing and replacement of dunnage bags; however, the materials are not generally designed to withstand pressures above around 10 to 15 pounds per square inch (psi). During use, the dunnage bags are ideally inflated to pressures of about 2 psi, substantially below the pressures at which the dunnage bags would fail.

A typical tractor trailer may use twenty or more dunnage bags at a time, such as using ten or more on each side of the interior of the trailer. A trucker or loader using the dunnage bags must manually position and inflate each dunnage bag to secure the cargo. Once positioned between the cargo and a wall of the vehicle, the dunnage bags are typically inflated by a pressure-regulated pneumatic supply. The supply pressure is regulated to a safe pressure for the dunnage bags, typically around 2 psi. Inflating the dunnage bags by a regulated source providing air at 2 psi typically corresponds to a relatively low air flow rate for inflation of the bags. Accordingly, the task of securing the cargo by positioning and inflating each dunnage bag can be quite time consuming.

### SUMMARY

One embodiment relates to a pneumatic cargo stabilization system that includes a first line configured to be coupled to a dunnage bag and configured to selectively convey a flow of a gas from a source to the dunnage bag, a second line in fluid communication with the gas in the dunnage bag, and a valve coupled in series with the first line, between the source and the dunnage bag. The valve includes a body that defines pressure supply port, a container port, and an exhaust port, a diaphragm assembly, and a spring member positioned to apply a biasing force to a first side of the diaphragm assembly, the second line conveying a feedback to a second side of the diaphragm assembly that opposes the biasing force. The diaphragm assembly is operable within the body to selectively: limit the flow of gas through the pressure supply port, the container port, and the exhaust port; place the pressure supply port in fluid communication with the container port; and place the container port in fluid communication with the exhaust port.

Another embodiment relates to a pneumatic system that includes a container defining an inner volume, a source configured to provide a pressurized flow of gas to the container, a first line having a first end and a second end, the first end being coupled to the container, a second line having an end in fluid communication with the inner volume of the container, and a valve having a pressure supply port coupled to the source, a container port coupled to the second end of the first line, and an exhaust port. The valve includes a diaphragm assembly operable to selectively control a flow of gas between the exhaust port, the pressure supply port, and the container port according to a first mode of operation whereby the pressure supply port is in fluid communication with the container port and a second mode of operation whereby the container port is in fluid communication with the exhaust port.

Yet another embodiment relates to a method of stabilizing cargo that includes coupling a container to a source of pressurized gas with a first line, controlling the pressure within the container with a valve disposed along the first line according to a first mode of operation whereby the source of pressurized gas is in fluid communication with the container and a second mode of operation whereby the container is in fluid communication with an exhaust, and compensating for changes in at least one of pressure and temperature within a surrounding environment using a second line configured to provide a feedback to a diaphragm assembly of the valve, the feedback actuating the valve between the first mode of operation and the second mode of operation.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a tractor trailer according to an exemplary embodiment of the invention;

FIG. 2 is a perspective view of an interior of a container for a tractor trailer according to an exemplary embodiment of the invention;

FIG. 3 is a schematic diagram of a pneumatic system in a first configuration according to an exemplary embodiment of the invention;

FIG. 4 is a schematic diagram of the pneumatic system of FIG. 3 in a second configuration;

FIG. 5 is a top view of a pneumatic system according to another exemplary embodiment of the invention;

FIG. 6 is a side view of the pneumatic system of FIG. 5;

FIG. 7 is an end view of the pneumatic system of FIG. 5;

FIG. 8 is a circuit diagram of a pneumatic system according to yet another exemplary embodiment of the invention;

FIG. 9 is a schematic diagram of a pneumatic system, according to an exemplary embodiment; and

FIG. 10 is a sectional view of a pneumatic system, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

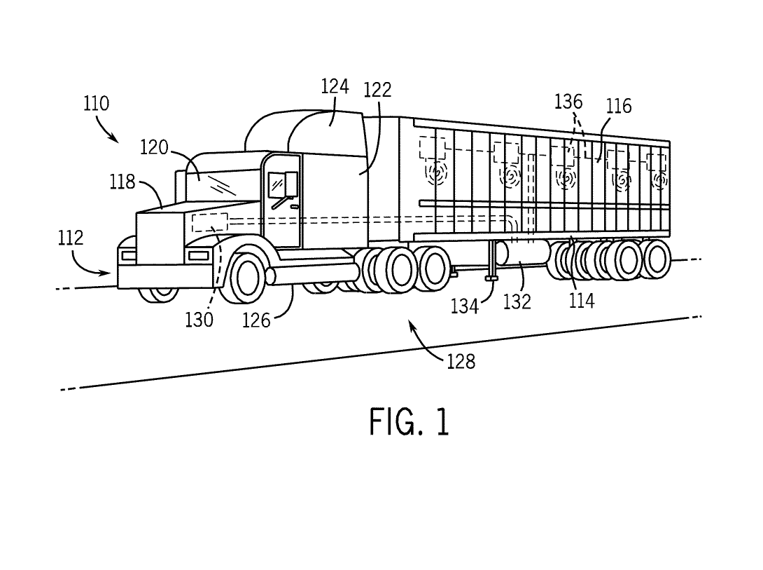

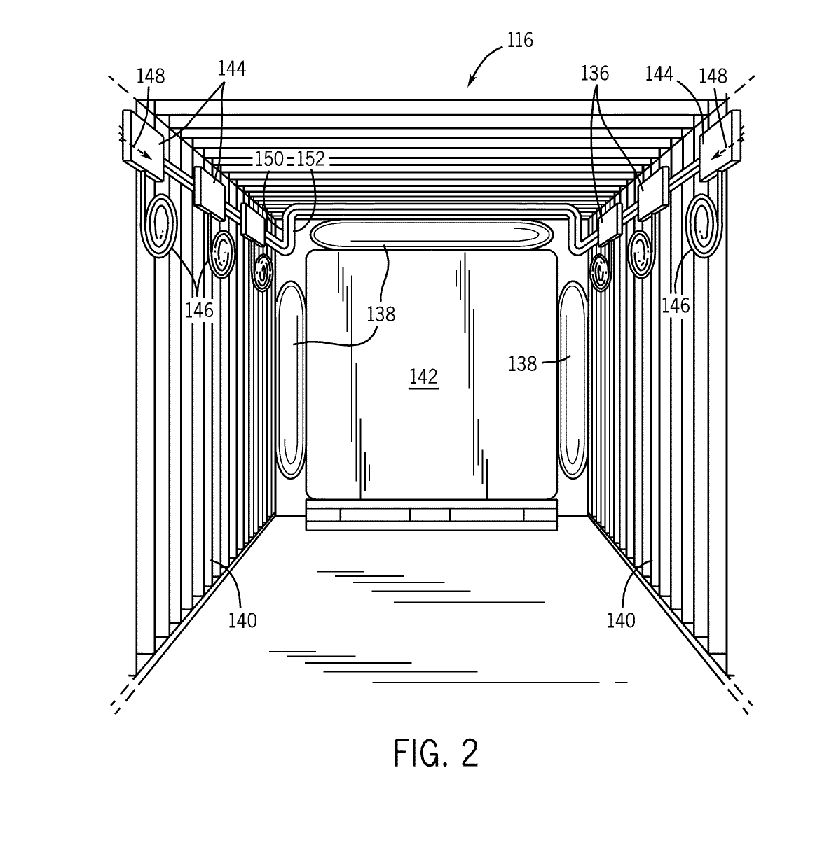

Referring to FIG. 1, a tractor trailer 110 includes a tractor 112 and a trailer 114 having a container 116 coupled thereto. The tractor 112 includes an engine compartment 118, a cabin 120, a sleeper 122, an air dam 124, and fuel tanks 126, among other components and features. The trailer 114 is coupled to the tractor 112, such as at a fifth wheel coupling 128. The container 116 of the trailer 114 includes cargo space therein (see FIG. 2), and may include landing gear 134 for use to support the container 116 when the trailer 114 is detached from the tractor 112.

According to an exemplary embodiment, the tractor trailer 110 includes one or more air compressors 130. One air compressor 130 may be located in the engine compartment 118. Another air compressor (not shown) may be located below the trailer 114. Yet another air compressor (not shown) may be located in or below the tractor 112. Still other air compressors or different sources of pressurized gas may be provided in other locations on the tractor trailer 110. In some embodiments, one or more air compressors are coupled to a receiver tank 132 (e.g., pressure vessel, etc.), which may in turn be coupled to air brakes, suspension components, tires, or to other portions of the tractor trailer 110 for operation thereof.

Referring to FIG. 2, the tractor trailer 110 further includes a pneumatic system 136 (see also FIG. 1) for inflation of dunnage bags 138 used in the container 116 of the trailer 114 to secure cargo therein. In some embodiments, the pneumatic system 136 is mounted to an interior wall 140 of the container 116, preferably above a load line, such that the valve system is accessible with cargo 142 present in the container 116.

In some embodiments, the pneumatic system 136 is connected to the receiver tank 132 and/or to other pressure vessels (e.g., one or more pressurized-gas cylinders, etc.). In other embodiments, the pneumatic system 136 is connected directly to one or more of the air compressors associated with the tractor trailer (e.g., tire inflation system, etc.). In still other embodiments, the pneumatic system 136 is connected to an auxiliary air compressor that is not associated with other functions or features of the tractor trailer 110, such as a commercially-available portable air compressor.

According to an exemplary embodiment, the pneumatic system 136 includes one or more stations 144 (e.g., drops, etc.) from which a fill line 146 (e.g., hose, tube, port, etc.) may be used to inflate one or more of the dunnage bags 138. According to an exemplary embodiment, the pneumatic system 136 includes two rows 148 of stations 144, with thirteen stations 144 in each row 148. One of the rows 148 is positioned along one side wall 140 of the interior of the container 116 and the other row 148 is positioned along the opposite side wall 140.

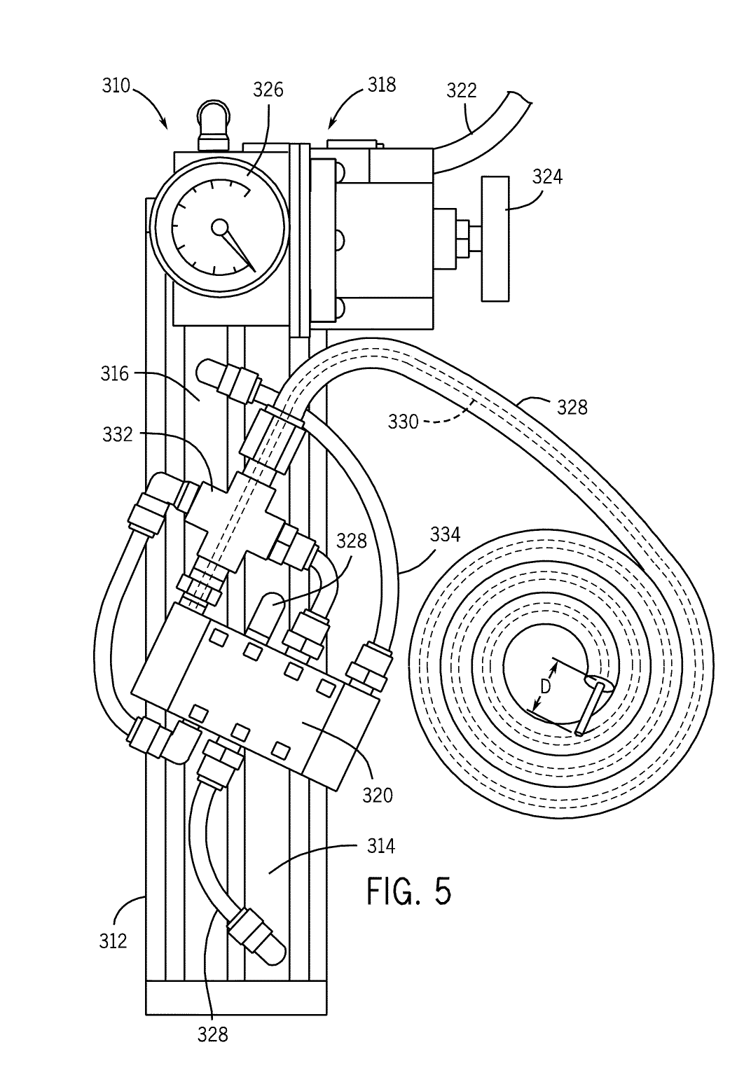

In some embodiments, the stations 144 and the two rows 148 are coupled together via a higher-pressure manifold 150 (e.g., 60 to 150 psi) that is in communication with a pressurized source of air or other gas, such as one or more of the air compressors 130 or the receiver tank 132. In such embodiments, the stations 144 and the two rows 148 are also coupled together via a lower-pressure manifold 152 (e.g., less than about 2 psi) that is in communication with a pressure-regulated source of air or other gas (see, e.g., pressure regulator 318 as shown in FIG. 5). The higher-pressure manifold 150 and the lower-pressure manifold 152 may be coupled together in a rigid structure mounted to the walls 140 of the container 116, such as an extruded metal (e.g., aluminum) or injection-molded plastic strip having the manifolds 150, 152 in parallel conduits formed therein (see, e.g., support structure 312 as shown in FIG. 5).

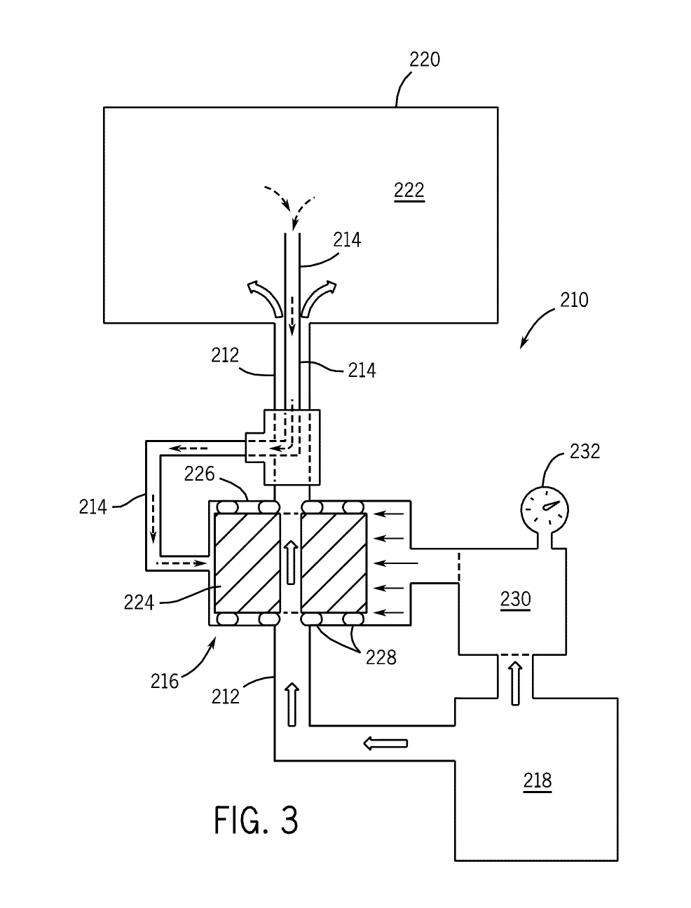

During use of the pneumatic system 136, the fill line 146 of a station 144 is connected to an inlet (e.g., opening, aperture, fill port) of one of the dunnage bags 138, shown as the inlet of the lower-pressure container 220 in FIG. 3. A flow-control element (e.g., valve, pneumatic switch, gate), shown as valve 216 in FIG. 3, in the station 144 selectively allows gas to inflate the dunnage bag 138 from the higher-pressure manifold 150. The pneumatic system 136 then controls the rapid inflation of the dunnage bag 138 by automatically halting the flow of gas from the higher-pressure manifold 150 when pressure in the dunnage bag 138 achieves a desired state, such as reaching or exceeding a predetermined threshold pressure corresponding to a safe-inflation pressure (e.g., 1.5 to 2.5 psi) for the dunnage bag 138. Inflating the dunnage bags 138 with gas from the higher-pressure manifold 150 increases the speed at which the dunnage bags 138 are inflated, relative to inflation from a source supplying gas at or proximate to the desired safe-inflation pressure. Following inflation, the fill line 146 may be decoupled from the dunnage bag 138 and stored or stowed in the container 116 of the trailer 114 or elsewhere.

Although shown, according to an exemplary embodiment, with the tractor trailer 110 for use with inflation of the dunnage bags 138, the present disclosure may be applied to a broad range of pneumatic control applications and inflation tasks, and may be used with various inflatable items. In some embodiments, a pneumatic system 136 may be used to control rapid inflation of inflatable shelters, rafts, air mattresses, dirigibles, etc. In some embodiments, gases other than air may be controlled. In one such contemplated embodiment, a pneumatic system is used to quickly and safely inflate helium balloons.

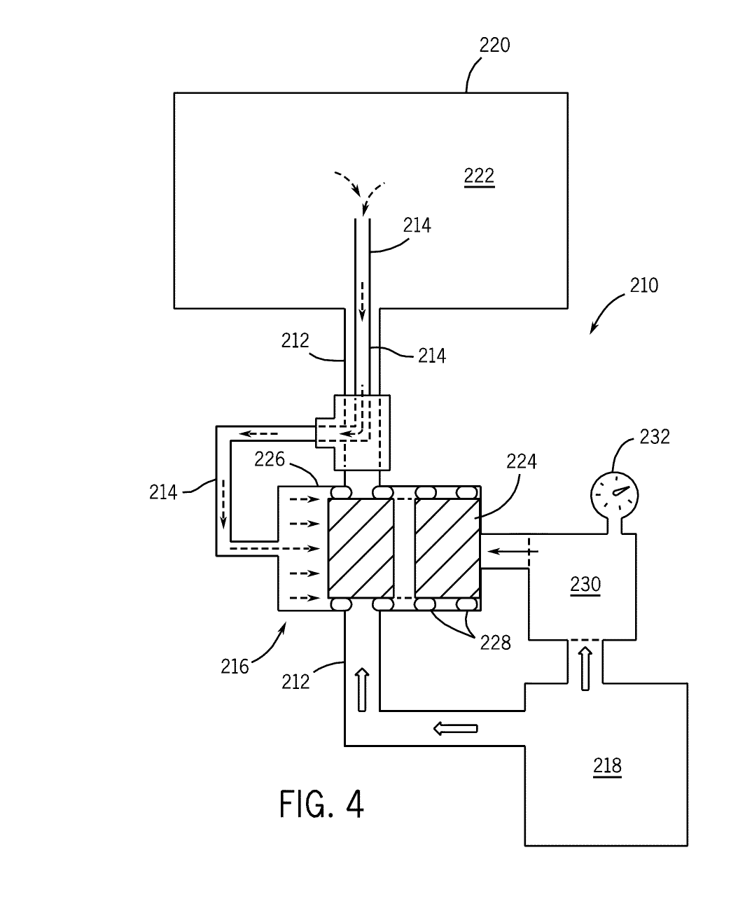

Referring now to FIGS. 3-4 a pneumatic system 210 includes a supply line 212 (e.g., first line, fill line, high-pressure conduit), a feedback line 214 (e.g., second line, low-pressure conduit), and a valve 216. The supply line 212 extends between a higher-pressure source 218 and a lower-pressure container 220 and is designed to convey gas from the higher-pressure source 218 to the lower-pressure container 220. The feedback line 214 is designed to be inserted into the volume 222 of the lower-pressure container 220 to be in communication with gas in the lower-pressure container 220. The valve 216 is designed to selectively interrupt (e.g., block, close, limit, etc.) the supply line 212 as a function of a characteristic of, or parameter associated with, the gas in the lower-pressure container 220, where the characteristic of or parameter associated with the gas in the lower-pressure container 220 is provided to the valve 216 via communication with the feedback line 214.

According to an exemplary embodiment, the valve is operated as a function of the pressure of the gas in the lower-pressure container 220. The feedback line 214 communicates the pressure of the gas in the lower-pressure container 220 to the valve 216. In some embodiments, the feedback line 214 is a feedback tube that is pressurized in accordance with the pressure of the gas in the lower-pressure container 220, and relays that pressure to the valve 216. In other embodiments, the feedback line is an electric wire that communicates a signal indicative of the pressure in the lower-pressure container to a mechanism (e.g., solenoid) associated with the valve. In still other embodiments, the feedback line includes a network of mechanical linkages that move as a function of the pressure of the gas in the lower-pressure container, and communicate the movement to the valve for operation thereof.

According to an exemplary embodiment, the valve 216 is a spool valve, a sleeve valve, a shuttle valve, or another form of valve designed to operate by sliding a valve gate 224 to selectively interrupt the supply line 212. In some embodiments, the valve 216 is more specifically a spool and sleeve valve, where the spool and sleeve are lapped together and operate within a valve housing 226 on a bearing 228, such as a low-friction air bearing. According to such an embodiment, the valve gate 224 is operated in response to relative pressures, one supplied by the feedback line 214 and another supplied by a pressure regulator 230. In other embodiments, mechanical bearings (e.g., ball bearings, roller bearings), other types of commercially-available bearings, or no bearings are used. In still other embodiments, the valve uses a diaphragm between the two pressures to operate the valve gate.

According to an exemplary embodiment, the pneumatic system 210 includes the pressure regulator 230, which is coupled to the high-pressure source 218 or to another source of pressurized gas. In some embodiments, the pressure regulator 230 is manually operated and is configured to control the pressure of the output thereof. In some such embodiments, the pressure regulator 230 is configured to supply an output pressure of 0 to 2 psi. A display 232 may be coupled to the pressure regulator 230 to indicate the pressure of the output or other information related to the flow of gas.

The pressure regulator 230 is used to supply a pilot pressure to the valve 216. In some embodiments, the pilot pressure is applied to one side of the valve gate 224 and the pressure of the gas in the lower-pressure container 220 is supplied to the opposite side of the valve gate 224 by way of the feedback line 214. Accordingly, when the pilot pressure supplied by the pressure regulator 230 is greater than the pressure of the lower-pressure container 220, the valve 216 is biased to the open position (see FIG. 3). When the pilot pressure supplied by the pressure regulator 230 is less than the pressure in the lower-pressure container 220, the valve 216 closes the supply line 212, halting the flow of gas into the lower-pressure container 220 (see FIG. 4).

In other embodiments, a spring member may be used to bias the valve gate, in place of or in conjunction with the pilot pressure supplied by the pressure regulator 230. However, use of pilot pressure alone may be preferred, because adjustment of the pressure regulator may serve to adjust a pilot pressure that is simultaneously supplied to more than one valve, if the pressure regulator is coupled to a lower-pressure manifold (see, e.g., lower-pressure manifold 316 as shown in FIG. 5) from which more than one pneumatic valve station is connected (see, e.g., row 148 as shown in FIG. 2).

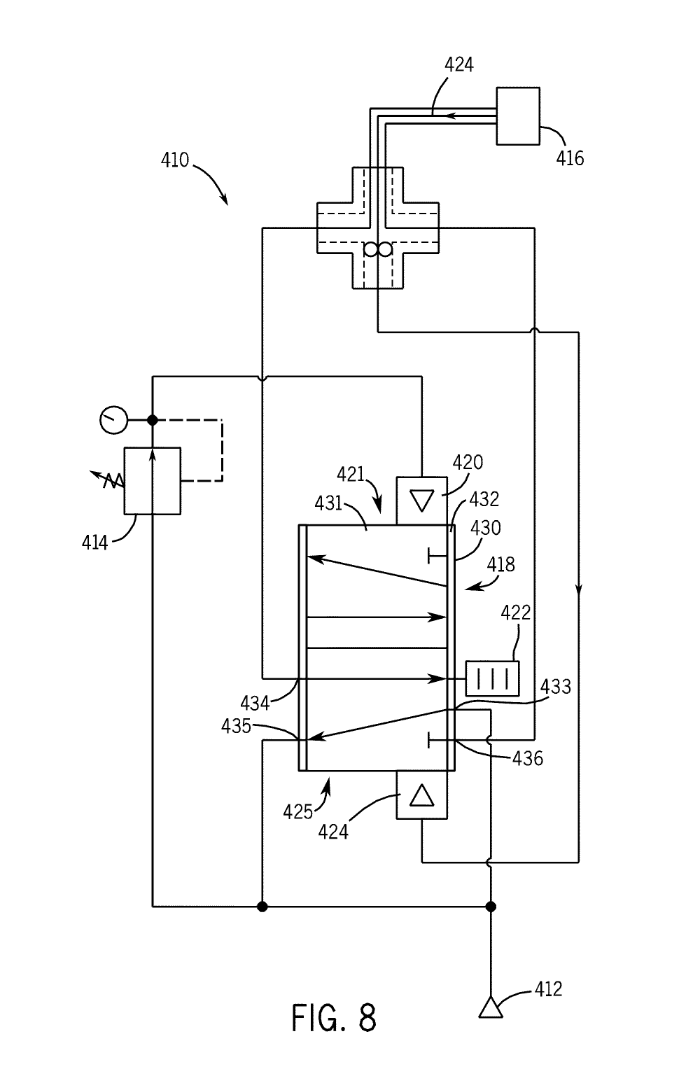

While FIGS. 3-4 show a simple spool valve having a closed cross-over position, in other embodiments the valve may be a pressure-relieving valve, a pressure-reducing valve, a modulating valve, a regulating valve, and/or a throttling valve (see, e.g., valve 418 of pneumatic system 410 as shown in FIG. 8). In some such embodiments, the valve is configured to both halt flow from the high-pressure source 218 and relieve pressure from the lower-pressure container 220 (see, e.g., exhaust port 422 as shown in FIG. 8).

In one contemplated application of such an embodiment including a pressure-relieving valve, the lower-pressure container 220 may have a pressure above a desired pressure even when the pressure-relieving valve is blocking the higher-pressure source, such as when the lower-pressure container 220 is transported to a higher elevation having a lower atmospheric pressure. In this contemplated application, the pressure-relieving valve would then relieve the pressure in the lower-pressure container 220, such as by venting excess gas. If the lower-pressure container 220 is then returned to a lower elevation, decreasing the pressure therein, the valve would then temporarily reopen the path between the higher-pressure source 218 and the lower-pressure container 220, as necessary, to return the lower-pressure container 220 to the desired pressure.

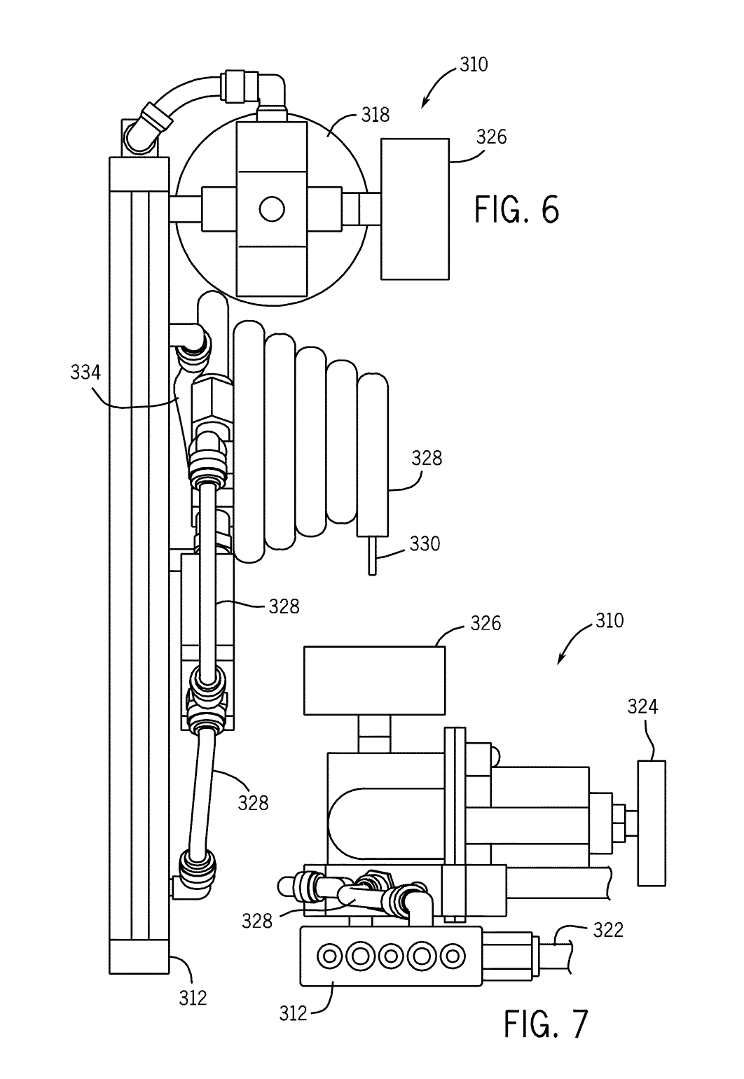

Referring now to FIGS. 5-7, a pneumatic system 310 includes a support structure 312 for a higher-pressure manifold 314 and a lower-pressure manifold 316, a pressure regulator 318, a valve 320, and associated plumbing. A conduit 322 receives pressurized gas from a source, such as a compressor (see, e.g., air compressor 130 as shown in FIG. 1), and provides the gas to the higher-pressure manifold 314 and to the pressure regulator 318. The pressure regulator 318 drops the pressure of the gas passing therethrough, and provides as output the lower-pressure gas to the lower-pressure manifold 316, which serves as a pilot pressure for the valve 320. According to an exemplary embodiment, the pressure regulator 318 includes a manually-operable control interface, shown as handle 324, that allows for changing of the regulated pressure setting. The pressure regulator 318 further includes a display 326, which identifies the output pressure (e.g., gauge pressure, pilot pressure, etc.).

According to an exemplary embodiment, a supply line 328 extends from the higher-pressure manifold 314 to the valve 320 and continues from the valve 320 to a container (e.g., inflatable; see, e.g., dunnage bag 138 as shown in FIG. 2). A feedback line 330 extends co-axially through the supply line 328 and projects into the container. The feedback line 330 projects from the end of supply line 328 into the container by a distance D (e.g., at least one inch) that allows the feedback line 330 to be sensitive to the pressure of gas in the container, without substantial influence from the pressurized gas supplied by the supply line 328. In some contemplated embodiments, the feedback line includes a hooking curvature extending away from the end of the supply line to further remove the inlet of the feedback line from the path of pressurized gas exiting the supply line.

According to an exemplary embodiment, the valve 320 is a directional control valve, such as a 5-port, 4-way directional control valve. In some such embodiments, the valve 320 has a lapped spool and sleeve valve gate that is slidable over an air bearing. Two conduits of the supply line 328 extend from the higher-pressure manifold 314 to supply pressurized gas to the valve 320. A second two conduits of the supply line 328 extend from the valve 320 to supply the pressurized gas to a cross-shaped juncture 332, when the valve 320 is open. Doubling of the conduits of the supply line 328 to and from the valve 320 doubles the capacity of the valve 320. The conduits of the supply line 328 are joined in the juncture 332, where the higher-pressure gas is conveyed through a single conduit of the supply line 328 to the container.

According to an exemplary embodiment, the feedback line 330 extends from the container through the supply line 328 and into the juncture 332, such as extending co-axially with the supply line 328 such that one line is inside the other (i.e., as opposed to the center axes of the lines being strictly aligned). According to a preferred embodiment, the feedback line 330 is narrower than the supply line 328, and extends co-axially therein. The feedback line 330 is further coupled to the valve 320 such that the pressure of the gas in the container, which is communicated via the feedback line 330, is delivered to the valve 320. Opposite to the connection with the feedback line 330, another conduit 334 extends from the lower-pressure manifold 316 to the valve 320 and supplies the pilot pressure thereto.

According to an exemplary embodiment, the valve 320 is operated as a function of the relative pressure of the gas in the container communicated via the feedback line 330 and the pilot pressure communicated via the conduit 334 coupled to the lower-pressure manifold 316. When the pilot pressure from the pressure regulator 318 exceeds the pressure of the container as communicated by the feedback line 330, the valve 320 is open. When the pilot pressure from the pressure regulator 318 is less than the pressure of the container as communicated by feedback line 330, the valve 320 is closed and gas conveyed to the container from the source by way of the higher-pressure manifold 314 is limited (e.g., blocked, reduced, etc.).

Referring now to FIG. 8, a circuit diagram of pneumatic system 410 includes a high-pressure supply 412, a pressure regulator 414 providing a low-pressure set point, a valve 418 used to control flow through the pneumatic system 410, and a receiver of the output 416 from the pneumatic system 410. A pilot pressure 420, corresponding to the low pressure set point, is provided to the valve 418 from the pressure regulator 414. The receiver of the output 416 also provides feedback 424 to the valve 418. In some embodiments, the feedback 424 is a pressure of gas in the receiver of the output 416. In other contemplated embodiments, the feedback 424 is another characteristic of or parameter associated with the gas in the receiver of the output 416, such as the present ratio of a mixture of gases, the present temperature of the gas, a sensed turbulence of the gas, etc.

According to an exemplary embodiment, the valve 418 is shown as a four-way directional control valve that has been configured to operate as a shutoff valve between the high-pressure supply 412 and the receiver of the output 416. According to an exemplary embodiment, the valve 418 includes a valve body 430, a valve gate 431, and an air bearing 432. In one embodiment, pressure regulator 414 provides pilot pressure 420 to a first end 421 of valve gate 431 and feedback 424 is provided to a second end 425 of valve gate 431. As shown in FIG. 8, the valve 418 includes a first port 433, a second port 434, a third port 435, and a fourth port 436. According to such an embodiment, the valve 418 opens the flow path between the high-pressure supply 412 and the receiver of the output 416 as a function of the feedback 424 and the pilot pressure 420 from the pressure regulator 414.

In some embodiments, when the pilot pressure 420 exceeds the pressure of gas in the receiver of the output 416, the valve 418 opens the flow path between first port 433 and second port 434, allowing gas to flow from the high-pressure supply 412 to the receiver of the output 416. When the pressure of the gas in the receiver of the output 416 exceeds the pilot pressure 420, the valve 418 closes the flow path. In some embodiments, the valve 418 may also provide access to an exhaust port 422 or vent, which may be used to relieve trapped pressure when the pneumatic system 410 is not actively supplying gas to the receiver of the output 416.

According to an exemplary embodiment, the pneumatic system 410 is an active system, allowing the system to respond to a dynamic environment. The high-pressure supply 412 remains coupled to the valve 418 and the valve remains coupled to the receiver of the output 416. If pressure in the receiver of the output 416 drops below a desired pressure level or range, then the valve 418 opens to allow the high-pressure supply 412 to be delivered thereto. If the pressure in the receiver of the output 416 rises above the desired pressure level or range, then the valve 418 opens the exhaust port 422, allowing gas to exit the receiver of the output 416. If pressure in the receiver of the output 416 reaches the desired pressure level or range, the valve 418 closes off the high-pressure supply 412 and the exhaust port 422 from the receiver of the output 416.

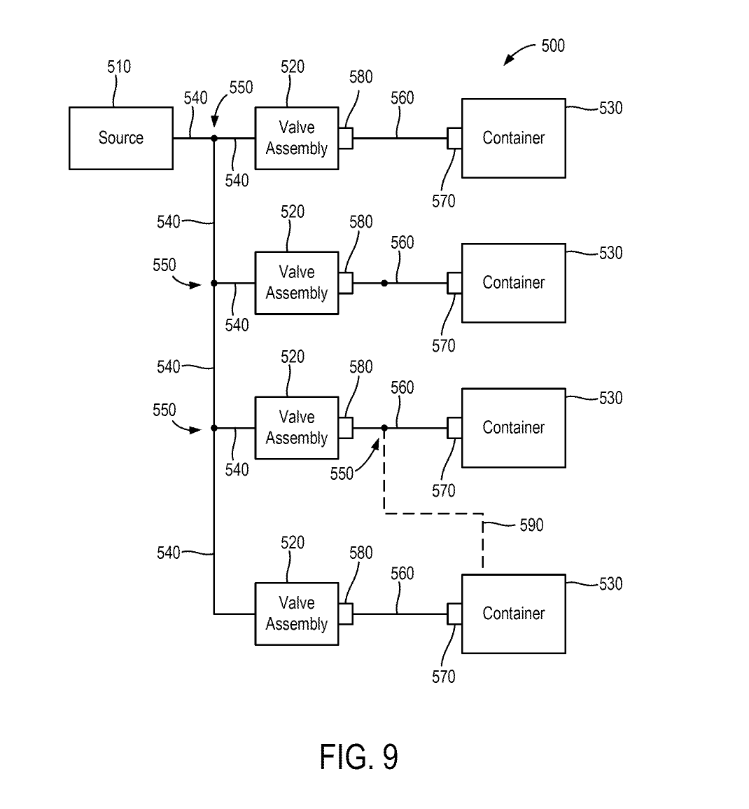

Referring next to the exemplary embodiment shown in FIG. 9, a pneumatic system, shown as cargo stabilization system 500, includes a source 510, a plurality of valve assemblies 520, and a plurality of containers 530. In one embodiment, the plurality of valve assemblies 520 are configured to regulate (e.g., maintain, actively control, etc.) the pressure within the plurality of containers 530. Source 510 is configured to provide gas at a pressure that is greater than the pressure of the gas within the plurality of containers 530, according to an exemplary embodiment. In one embodiment, source 510 includes an air compressor. In another embodiment, source 510 includes a pressurized tank of gas (e.g., a container configured to contain a gas at a pressure greater than the pressure of gas within container 530, etc.). Source 510 provides pressurized gas to the plurality of valve assemblies 520 via a plurality of pressurized lines 540 and a plurality of “T” connectors 550, according to an exemplary embodiment. As shown in FIG. 9, T connectors 550 are indirectly coupled to valve assemblies with pressurized lines 540. According to an alternative embodiment, T connectors 550 are directly coupled to valve assemblies 520. Intermediate lines 560 couple the plurality of containers 530 to the plurality of valve assemblies 520. As shown in FIG. 9, a plurality of connectors 570 couple the intermediate lines 560 to the plurality of containers 530, and a plurality of connectors 580 couple the intermediate lines 560 to valve assembly 520. In one embodiment, containers 530 are dunnage bags having male threaded connections. The plurality of connectors 570 may include female threaded connections that are configured to engage the male threaded connections of the dunnage bags.

As shown in FIG. 9, cargo stabilization system 500 includes four valves that are each positioned to regulate the pressure within a corresponding container 530. In other embodiments, more or fewer valve assemblies 520 may be coupled to more or fewer containers 530. By way of example, a second intermediate pneumatic line 590 may be used to couple a single valve assembly 520 to a plurality of containers 530 (e.g., two containers, etc.). In one embodiment, a pressure feedback is provided to the valve assembly 520 from a master container 530, and the pressure feedback is used to control the pressure within the master container 530 and one or more slave containers 530. Such an arrangement may be facilitated by the second intermediate pneumatic line 590. The second intermediate pneumatic line 590 replaces the valve assembly 520 and the intermediate line 560 otherwise associated with the slave container 530, according to an exemplary embodiment.

In one embodiment, each valve assembly 520 is individually adjustable. Valve assemblies 520 that are individually adjustable facilitate individually regulating the pressure within containers 530. In other embodiments, the valve assemblies 520 may be adjusted together using a central adjustment system. The central adjustment system may include a pressure source (e.g., source 510, a pressure source and a pressure regulator, etc.) that is configured to provide a pilot pressure to the valve assemblies 520. The pilot pressure may provide a biasing force to valve assemblies 520. A pressure regulator may be disposed along a fluid path between the pressure source and the valve assemblies 520.

In one embodiment, the plurality of containers 530 include dunnage bags configured to stabilize (e.g., reduce movement of, secure, etc.) cargo. By way of example, the dunnage bags may be positioned between cargo and the wall of a tractor trailer, railroad car, cargo shipping container, or other device used to transport goods. One or more dunnage bags may also be positioned between different portions of a cargo load.

According to an exemplary embodiment, valve assemblies 520 control the flow of gas between the various components of cargo stabilization system 500 (e.g., from source 510, from containers 530, etc.) according to at least two modes of operation. In a first mode of operation, valve assemblies 520 are configured to place source 510 in fluid communication with container 530, thereby filling containers 530 or increasing the pressure of the gas within container 530. In a second mode of operation, valve assemblies 520 are configured to exhaust gas from containers 530 (e.g., through a vent or exhaust port, etc.), thereby reducing the pressure of the gas within containers 530. In other embodiments, valve assemblies 520 control the flow of gas according to a third mode of operation whereby source 510 is decoupled (e.g., not in fluid communication with, etc.) containers 530 and gas from within containers 530 is not exhausted. Such a third mode of operation may embody a “constant” or “system maintain” condition whereby the pressure of the gas within containers 530 is not increased or decreased by valve assemblies 520.

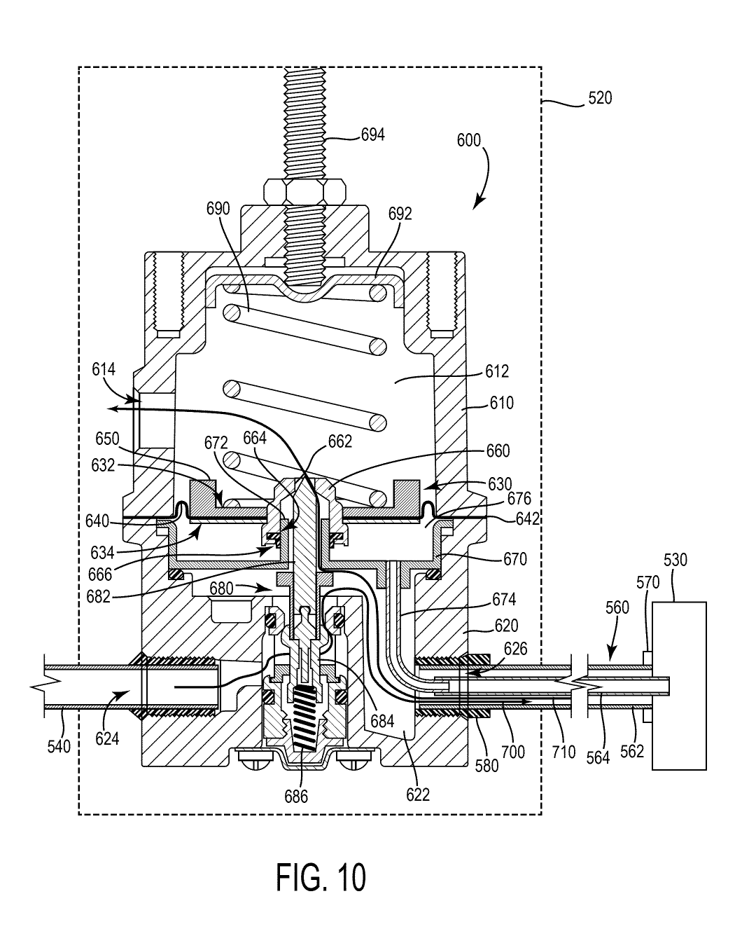

Referring next to the exemplary embodiment shown in FIG. 10, valve assembly 520 includes a flow control device, shown as valve 600. In one embodiment, container 530 is a dunnage bag, and valve 600 is configured to remain connected to the dunnage bag. Valve 600 may actively regulate (e.g., during a transport operation, etc.) the flow of gas (e.g., from source 510, from containers 530, etc.) to maintain the pressure within the dunnage bag and compensate for changes in pressure therein due to forces applied to the dunnage bag by the cargo (e.g., forces generated during cornering or acceleration, etc.), variations in ambient temperature, variations in ambient pressure, or still other conditions. Variations in temperature and ambient pressure (e.g., due to elevation changes) may occur even in short-haul trucking applications. Valve 600 actively regulates the flow of gas to maintain the pressure within a dunnage bag, thereby reducing damage to cargo that may otherwise occur as the dunnage bag deflates (e.g., due to a decrease in ambient temperature, as the tractor trailer travels into higher elevations, etc.). Valve 600 also actively regulates the flow of gas to reduce the risk of bursting the dunnage bag (e.g., due to an increase in ambient temperature, from a reduction in operating elevation as the tractor trailer travels into lower elevations from higher elevations, etc.).

As shown in FIG. 10, valve 600 includes a body having a first housing portion, shown as first shell 610, and a second housing portion, shown as second shell 620. In one embodiment, first shell 610 defines an inner chamber 612, and second shell 620 defines an inner chamber 622. According to an exemplary embodiment, valve 600 includes a moveable element, shown as diaphragm assembly 630. In one embodiment, valve 600 does not include a spool valve disposed within an air bearing. Valve 600 having diaphragm assembly 630 reduces the risk of seizing that may otherwise occur within traditional valves as debris engages sliding engagement surfaces.

As shown in FIG. 10, diaphragm assembly 630 includes a resilient member, shown as diaphragm 640. Diaphragm 640 has a periphery 642 that is secured (e.g., retained, held, etc.) between mating portions of first shell 610 and second shell 620, according to an exemplary embodiment. Diaphragm assembly 630 also includes a cup 650 having an aperture that receives a bushing 660. As shown in FIG. 10, bushing 660 defines a first aperture 662 and a second aperture 664. A seal 666 couples bushing 660 with a projection 672 of a feedback cup 670. Feedback cup 670 includes an aperture that receives a tube 674, according to an exemplary embodiment. A poppet assembly 680 is configured to selectively engage diaphragm assembly 630 and second shell 620, according to an exemplary embodiment. As shown in FIG. 10, poppet assembly 680 includes a shaft 682 that is coupled to a poppet 684. A resilient member, shown as spring 686, is positioned to bias poppet 684 into engagement with second shell 620.

Referring still to FIG. 10, a resilient member, shown as spring 690, is disposed within inner chamber 612 of first shell 610. According to an exemplary embodiment, spring 690 is positioned to apply a force (e.g., a biasing force, etc.) to a first side 632 of diaphragm assembly 630 (e.g., directly, indirectly, etc.). In one embodiment, the force applied by spring 690 is related to a preset pressure for the gas within container 530. According to an alternative embodiment, a pilot pressure (e.g., as applied by a regulated line in fluid communication with source 510, etc.) is configured to produce a force on first side 632 of diaphragm assembly 630. The pilot pressure may be applied to a plurality of valves 600 (e.g., using a plurality of lines, etc.) such that adjustment of the preset pressure for the gas within container 530 may occur by way of a single adjustment of the pilot pressure.

As shown in FIG. 10, spring 690 extends between cup 650 and an adjustment member 692. Spring 690 is under a preload, according to an exemplary embodiment, whereby the length of spring 690 is decreased from a free length thereof. As shown in FIG. 10, an adjuster, shown as screw 694, engages (e.g., is threaded into, etc.) first shell 610 and has an end that contacts adjustment member 692 to preload spring 690. Screw 694 may be adjusted (e.g., threaded inward, threaded outward, etc.) to increase or decrease the preload of spring 690 and thereby increase or decrease the preset pressure for the gas within container 530.

According to an exemplary embodiment, first shell 610 defines a port (e.g., exhaust port, vent port, pressure regulation port, etc.), shown as port 614. Port 614 is in fluid communication with an ambient environment, according to an exemplary embodiment. As shown in FIG. 10, second shell 620 defines a first port (e.g., pressure supply port, inlet port, main port, line port, etc.), shown as port 624, and a second port (e.g., container port, inlet/outlet port, load port, etc.), shown as port 626. Port 624 is in fluid communication with source 510, and port 626 is in fluid communication with the gas within container 530, according to an exemplary embodiment.

According to the exemplary embodiment shown in FIGS. 9-10, diaphragm assembly 630 controls the flow of gas between port 614, port 624, and port 626 (e.g., from source 510, to container 530, from container 530, etc.) according to at least two modes of operation. In a first mode of operation, diaphragm assembly 630 is operable within first shell 610 and second shell 620 to selectively place port 624 in fluid communication with port 626 (e.g., to place source 510 in fluid communication with container 530), thereby filling containers 530 or increasing the pressure of the gas within container 530. In a second mode of operation, diaphragm assembly 630 is operable within first shell 610 and second shell 620 to place port 626 in fluid communication with port 614 (e.g., to exhaust gas from container 530, to place container 530 in fluid communication with port 614, etc.), thereby reducing the pressure of the gas within container 530. In other embodiments, diaphragm assembly 630 controls the flow of gas between port 614, port 624, and port 626 according to a third mode of operation. In the third mode of operation, diaphragm assembly 630 is operable within first shell 610 and second shell 620 to decouple port 624 from port 626 (e.g., such that port 624 is not in fluid communication with port 626, etc.) and decouple port 626 from port 614. Accordingly, diaphragm assembly 630 is operable within first shell 610 and second shell 620 to limit the flow of gas through port 624, port 626, and port 614. Such a third mode of operation may embody a constant or system maintain condition whereby the pressure of the gas within container 530 is not increased or decreased.

Referring still to FIG. 10, valve 600 is configured to provide gas from pressurized lines 540 to a first line 562, of intermediate line 560. A second line 564 is coupled to tube 674 and configured to convey a feedback pressure of the gas within the container 530. In one embodiment, the feedback pressure selectively engages at least one of valve 600 and diaphragm assembly 630 between the various operating modes. Second line 564 and tube 674 convey the feedback pressure to a feedback chamber 676 defined at least in part by feedback cup 670 and diaphragm assembly 630. In one embodiment, the feedback pressure of the gas within the container 530 produces a force (e.g., a feedback force, etc.) that is applied to second side 634 of diaphragm assembly 630. The force produced by the feedback pressure opposes the force applied by spring 690, according to an exemplary embodiment. In other embodiments, the force applied by spring 686 also opposes the force applied by spring 690. Diaphragm assembly 630 is actuated by the differential between the force applied by spring 690 and the force produced by the feedback pressure, according to an exemplary embodiment, to selectively actuate poppet assembly 680.

According to the exemplary embodiment shown in FIG. 10, first shell 610 and second shell 620 define a first flow path, shown as fill flow path 700, and a second flow path, shown as exhaust flow path 710. In the first mode of operation, the force applied by spring 690 is greater than the force produced by the feedback from the pressure within container 530 and the force applied by spring 686. Such a differential forces bushing 660 into engagement with shaft 682. The force differential also generates downward movement of diaphragm assembly 630 (e.g., movement further into inner chamber 622, into a first position, etc.) and disengages poppet 684 from second shell 620, according to an exemplary embodiment. Gas from source 510 may flow through valve 600 from port 624 to port 626 along fill flow path 700. Such a condition may occur when the pressure of the gas within container 530 falls below a preset value (e.g., when the tractor trailer travels into lower elevations from higher elevations, when the ambient temperature decreases, etc.). In the second mode of operation, the force applied by the feedback from the pressure within container 530 and the force applied by spring 686 overcomes the force applied by spring 690. Such a force differential generates upward movement of diaphragm assembly 630 (e.g., into a second position, etc.) that disengages bushing 660 from shaft 682. Gas from container 530 may flow through valve 600 from port 626 to port 614 along exhaust flow path 710. Such a condition may occur where the pressure within container 530 exceeds the preset value (e.g., when the tractor trailer travels into higher elevations from lower elevations, when the ambient temperature increases, etc.). In the third mode of operation, the force applied by the feedback from the pressure within container 530 and the force applied by spring 686 is within a deadband zone of the force applied by spring 690.

Valve 600 is configured to control the flow of gas through first line 562 as a function of the pressure of the gas within container 530. According to an exemplary embodiment, valve 600, intermediate line 560, and source 510 are configured to remain selectively engaged with container 530 during normal operation. By way of example, connector 570 may remain coupled to container 530 over an entire period of operation (e.g., during an entire transportation operation as goods are moved from one location to another, etc.). Cargo stabilization system 500 may actively maintain the pressure within container 530 without electronic components (i.e., the pressure within container 530 is mechanically controlled by valve 600), thereby reducing the cost and complexity of the system. In one embodiment, cargo stabilization system 500 provides a mechanical system that provides active control of the gas within a dunnage bag or other container.

The construction and arrangements of the pneumatic system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pneumatic cargo stabilization system, comprising:
a first line configured to be coupled to a dunnage bag and configured to selectively convey a flow of a gas from a source to the dunnage bag;
a second line in fluid communication with the gas in the dunnage bag;
a valve coupled in series with the first line, between the source and the dunnage bag, wherein the valve comprises:
a body that defines pressure supply port, a container port, and an exhaust port;
a diaphragm assembly operable within the body to selectively: limit the flow of gas through the pressure supply port, the container port, and the exhaust port; place the pressure supply port in fluid communication with the container port; and place the container port in fluid communication with the exhaust port; and
a spring member positioned to apply a biasing force to a first side of the diaphragm assembly, the second line conveying a feedback to a second side of the diaphragm assembly that opposes the biasing force.

2. The pneumatic cargo stabilization system of claim 1, wherein the first line is coupled to the container port of the body of the valve.

3. The pneumatic cargo stabilization system of claim 2, wherein the second line extends between the dunnage bag and the valve within the first line.

4. The pneumatic cargo stabilization system of claim 3, wherein the diaphragm assembly includes a diaphragm movably coupling a bushing to the body of the valve.

5. The pneumatic cargo stabilization system of claim 4, wherein the second line has an end that projects through the container port and into an inner volume defined by the body.

6. The pneumatic cargo stabilization system of claim 5, wherein the valve includes a feedback cup coupled to the bushing and the end of the second line.

7. The pneumatic cargo stabilization system of claim 6, wherein the feedback cup and the diaphragm assembly at least partially define a feedback chamber, and wherein the second line places the dunnage bag in fluid communication with the feedback chamber, the pressure within the feedback chamber producing a feedback force to the second side of the diaphragm assembly.

8. The pneumatic cargo stabilization system of claim 7, wherein the dunnage bag is configured to stabilize cargo during a transportation process and wherein the first line and the second line are configured to remain in fluid communication with the dunnage bag during the transportation process, the valve maintaining pressure within the dunnage bag to compensate for changes in at least one of pressure and temperature within a surrounding environment.

9. The pneumatic cargo stabilization system of claim 1, wherein the valve controls the flow of gas through the first line as a function of a differential between the biasing force and the feedback.

10. The pneumatic cargo stabilization system of claim 9, wherein the feedback actuates the diaphragm assembly between a first position and a second position, the diaphragm assembly placing the pressure supply port in fluid communication with the container port when in the first position and placing the container port in fluid communication with the exhaust port when in the second position.

11. A pneumatic system, comprising:
a container that defines an inner volume;
a source configured to provide a pressurized flow of gas to the container;
a first line having a first end and a second end, wherein the first end is coupled to the container;
a second line having an end in fluid communication with the inner volume of the container; and
a valve having a pressure supply port coupled to the source, a container port coupled to the second end of the first line, and an exhaust port, wherein the valve includes a diaphragm assembly operable to selectively control a flow of gas between the exhaust port, the pressure supply port, and the container port according to a first mode of operation whereby the pressure supply port is in fluid communication with the container port and a second mode of operation whereby the container port is in fluid communication with the exhaust port.

12. The pneumatic system of claim 11, wherein the diaphragm assembly is operable according to a third mode of operation that limits the flow of gas between the exhaust port, the pressure supply port, and the container port.

13. The pneumatic system of claim 11, wherein the valve includes a resilient member positioned to apply a biasing force to a first side of the diaphragm assembly, the second line providing a feedback to a second side of the diaphragm assembly that opposes the biasing force.

14. The pneumatic system of claim 13, wherein the valve is configured to control the flow of gas according to the first mode of operation or the second mode of operation based on a differential between the feedback and the biasing force.

15. The pneumatic system of claim 14, wherein the feedback actuates the valve into the second mode of operation when the pressure in the container exceeds a desired pressure level.

16. The pneumatic system of claim 15, wherein the valve includes a feedback cup coupled to a second end of the second line, wherein the feedback cup and the diaphragm assembly at least partially define a feedback chamber, and wherein the second line places the container in fluid communication with the feedback chamber, the pressure within the feedback chamber producing a feedback force that opposes the biasing force.

17. The pneumatic system of claim 16, wherein the container comprises a dunnage bag.

18. A method of stabilizing cargo, comprising:
coupling a container to a source of pressurized gas with a first line;
controlling the pressure within the container with a valve disposed along the first line according to a first mode of operation whereby the source of pressurized gas is in fluid communication with the container and a second mode of operation whereby the container is in fluid communication with an exhaust; and
compensating for changes in at least one of pressure and temperature within a surrounding environment using a second line configured to provide a feedback to a diaphragm assembly of the valve, the feedback actuating the valve between the first mode of operation and the second mode of operation.

19. The method of claim 18, further comprising disposing the container along a cargo load.

20. The method of claim 19, further comprising placing the second line in fluid communication with an inner volume of the container.
